(19) United States
(12) Patent Application Publication
(10) Pub. No.: US 2012/0215561 A1
(43) Pub. Date: Aug. 23, 2012

(54) Online integrating system for anamnesis

(75) Inventors: Jiunn-Rong CHEN, Tainan City (TW); Shiu-Min Liao, Tainan City (TW); Chun-Lin Juan, Tainan City (TW); Yi-Han Wu, Tainan City (TW)

(73) Assignee: Yuekang HealthCare Management Consultants, Inc.

(21) Appl. No.: 13/360,803

(22) Filed: Jan. 29, 2012

(30) Foreign Application Priority Data
Jan. 31, 2011 (TW) 100103664

(51) Int. Cl. G06Q 50/24

(52) U.S. Cl. 705/3

(57) ABSTRACT

An online integrating system for anamnesis includes a server and a database. The server hosts a website thereon, and the database stores a plurality of anamnesis data for at least one patient therein. The online integrating system integrates the plurality of anamnesis data stored in the database and generate correlations between each of the plurality of the anamnesis data for each patient. A user can login to the website via networking system by using an external computer, and selects a specific one of the plurality of anamnesis data from the website and the online integrating system will retrieve the related anamnesis data then display the relevant anamnesis data through a presenting page on the website.

### BACKGROUND OF THE INVENTION

1. Field of the Invention

The invention relates to an integrating system and in particular to an integrating system for anamnesis data of a patient.

2. Description of the Related Art

Traditionally, when a patient goes to a hospital for an outpatient procedure, the doctor generally formulates anamnesis of the patient. The paper anamnesis records the diagnostic results of the doctor, the data obtained from inspective apparatus and it is sorted by date.

However, large amount of paper anamnesis requires precious storage area, and it is difficult to store anamnesis data of a patient properly because the paper anamnesis can be easily damaged and lost. It is also very inconvenient if doctors wish to quickly search for data in the paper anamnesis. Once the anamnesis data of the patient is incomplete, it may affect the doctor's diagnosis.

Therefore, most hospitals presently adopt healthcare information system (HIS) to manage the anamnesis of patients freeing from the drawbacks mentioned earlier. HIS is an electronic system for managing anamnesis, recording the medical information of a patient, sorting by date of the examination and storing the diagnostic results of the doctor and determined data of inspective apparatus in a database of a computer. The main advantage of HIS is that as long as the patient has diagnostic records in the hospital, when the patient needs future outpatient procedures performed, the doctor of the said hospital may enter the identification information of the patient into the computer to quickly query the past anamnesis of the patient.

However, in the traditional HIS, the numerous examination data of the patient is stored in different data folders and a doctor needs to search various different data folders to find the necessary medical reports for one patient. For example, when a patient goes to hospital to see a cardiologist, the doctor needs to look for cardiac echo exam reports in cardiac echo folder, blood exam data from lab reports folder, and perhaps search in pharmaceutical folder to see if medication require adjustments. The doctor needs to tediously search in myriad of places, opening and closing each report folders repeatedly, trying to piece together current condition of the patient. Hence the doctor needs to do much work to formulate a proper diagnosis and this is a failure of the traditional HIS system whereby it does not fully integrate all of the necessary data for the doctor.

Furthermore, doctors are not able to quickly learn of patient's health status in a certain period via the current HIS system; doctors can not determine the actual therapeutic effect of certain treatment regime, or whether the patient's drug dosages are appropriate and being followed precisely outside of the hospital staff monitoring. Doctors may change medication prescription and the HIS system fails to notify the doctor that the medication would be ineffective or has had caused adverse side effects previously to the patient. Hence this is the inadequecy of HIS resulting in poor medical treatment efficacy prescribed by the doctor and causes further pain and suffering for the patient.

Through diligent research and development process, the inventor designs the online integrating system for anamnesis to embody all of patient's data in one place to enable the doctor, patient, or other approved users to login to the online integrating system to quickly query the desired data.

### SUMMARY OF THE INVENTION

The object of present invention is to provide an online integrating system for anamnesis where the database will store and correlate the plurality of patient anamnesis data. This will enable the user to query all of patient medical data on the website and only displays the relevent information needed.

To achieve the above object, the present invention, online integrating system for anamnesis, comprises of a server and a database. The server hosts a website thereon, and the database stores a plurality of anamnesis data for at least one patient therein. The online integrating system integrates the plurality of anamnesis data stored in the database and constructs correlations between each of the plurality of anamnesis data. A user can login to the website platform via various means of networked equipment, such as an computer, and selects a specific patient anamnesis data. The online integrating system retrieves all relevent anamnesis data and displays the data on the corresponding displaying page.

Compared to prior art, the following are the advantages of the present invention, online integrating system for anamnesis:

Firstly, the online integrating system can construct a correlation among the plurality of anamnesis data of a patient and only displays relevant information to the user. The unrelated information are not displayed to minimize confusion and reduce screen clutter. Also the invention employs new data retrieval method to display relevant plurality of diseases all at one time compared to previous art which can only display one disease at a time.

Secondly, by utilizing network and internet protocols connecting to various cooperating hospital systems, the database can retrieve desired outpatient records, physical exam data, admission data, and also self-check data entered by patient themselves and store into the integration database system. The online integration system will combine and process all of the relevant data and present the most accurate information to the user.

Thirdly, the system can convert laboratory exam results into numerical representation for further reporting analysis and can also highlight and place emphasis on key words found in imaging report (e.g. chest radiograph) and written reports, e.g. tumor size, to facilitate user in better understanding of patient's health status from exam and reports.

### BRIEF DESCRIPTION OF THE DRAWINGS

FIG. 1 shows a schematic view of an online integrating system of a preferred embodiment according to the invention.

FIG. 2 shows a schematic view of anamnesis data of the database of a preferred embodiment according to the invention.

FIG. 3 shows a framework view of integrating data of a preferred embodiment according to the invention.

FIG. 4A shows a schematic view of displaying page of a preferred embodiment according to the invention.

FIG. 4B shows a schematic view of displaying page of another preferred embodiment according to the invention.

FIG. 5 shows a flow chart of a preferred embodiment according to the invention.

### DETAILED DESCRIPTION OF THE INVENTION

Referring now to the drawings illustrating a preferred embodiment of the invention, detailed description as follows:

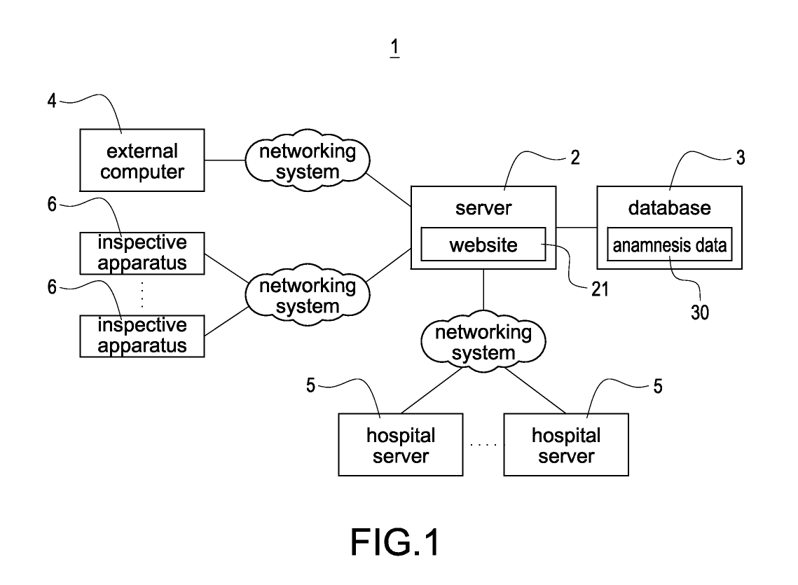

Firstly, please refer to FIG. 1, which is a schematic view of an online integrating system of a preferred embodiment according to the invention. The online integrating system for anamnesis (hereinafter referred as integrating system 1) according to the present invention mainly comprises a server 2 and a database 3 connected to the server 2. The database 3 stores a plurality of anamnesis data 30 for at least one patient therein. The server 2 hosts a website 21 thereon. A user can login to the website 21 via networking system (internet or intranet) by using an external computer 4, and query anamnesis data 30 of the patient in the database 3.

The integrating system 1 further comprises hospital server 5 in at least one hospital. The hospital server 5 is connected to the server 2 by networking system. After the patient completes any of the medical treatment such as outpatient procedure, physical exam or diagnostic examination in the hospital, the hospital server 5 will upload those records of the medical treatment to update patient anamnesis data 30 in the database 3.

Also, the integrating system 1 further comprises at least one inspective apparatus 6 connected to the server 2 by networking system. The inspective apparatus 6 may be located in the patient's home or carried by the patient. Accordingly, the patient can perform physiological measurement by using the inspective apparatus 6, and upload the physiological data to update patient anamnesis data 30 in the database 3. The inspective apparatus 6 may be used to measure data such as systolic blood pressure (SBP), diastolic blood pressure (DBP), mean arterial pressure (MAP), pulse pressure, heart rate, blood sugar, body temperature or oxygen saturation (SPO₂) but not limited thereto.

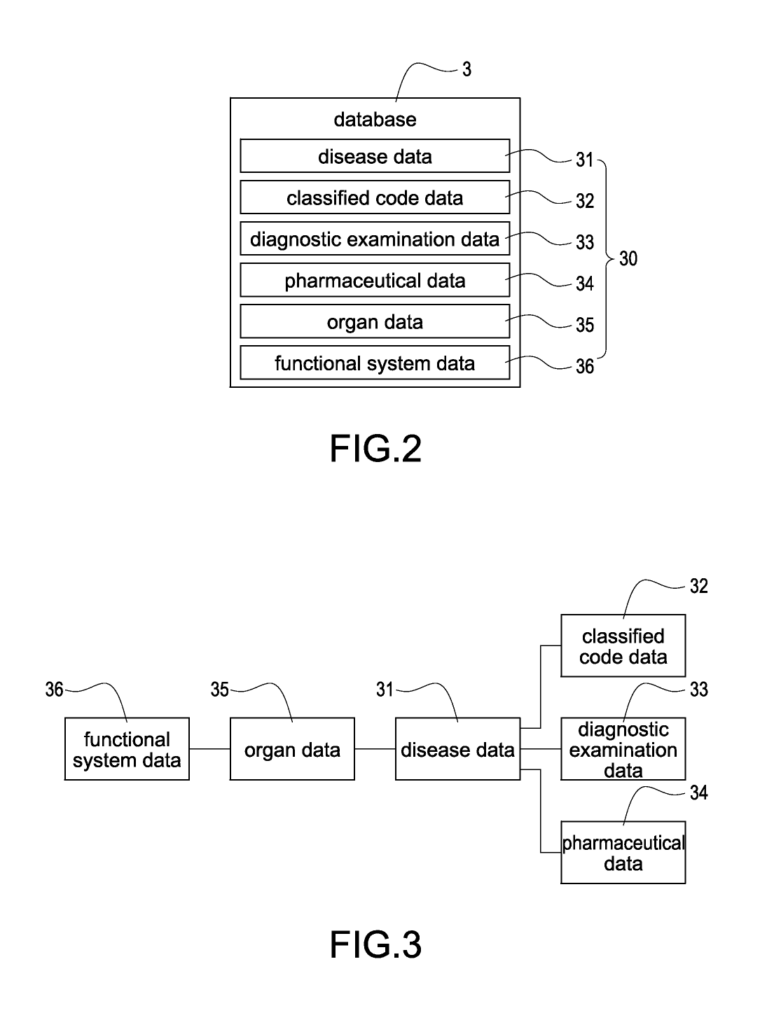

Please refer to FIG. 2, which is a schematic view of anamnesis data of the database of a preferred embodiment according to the invention. The plurality of anamnesis data 30 of the database 3 include disease data 31 of patients, classified code data 32, diagnostic examination data 33, pharmaceutical data 34, organ data 35 and functional system data 36. However, the above example is only a preferred embodiment for describing the invention. The invention should not be restricted to the above example. For example, plurality of the anamnesis data 30 stored in the database 3 should not be limited in number or type, and may change in number and or type if necessary.

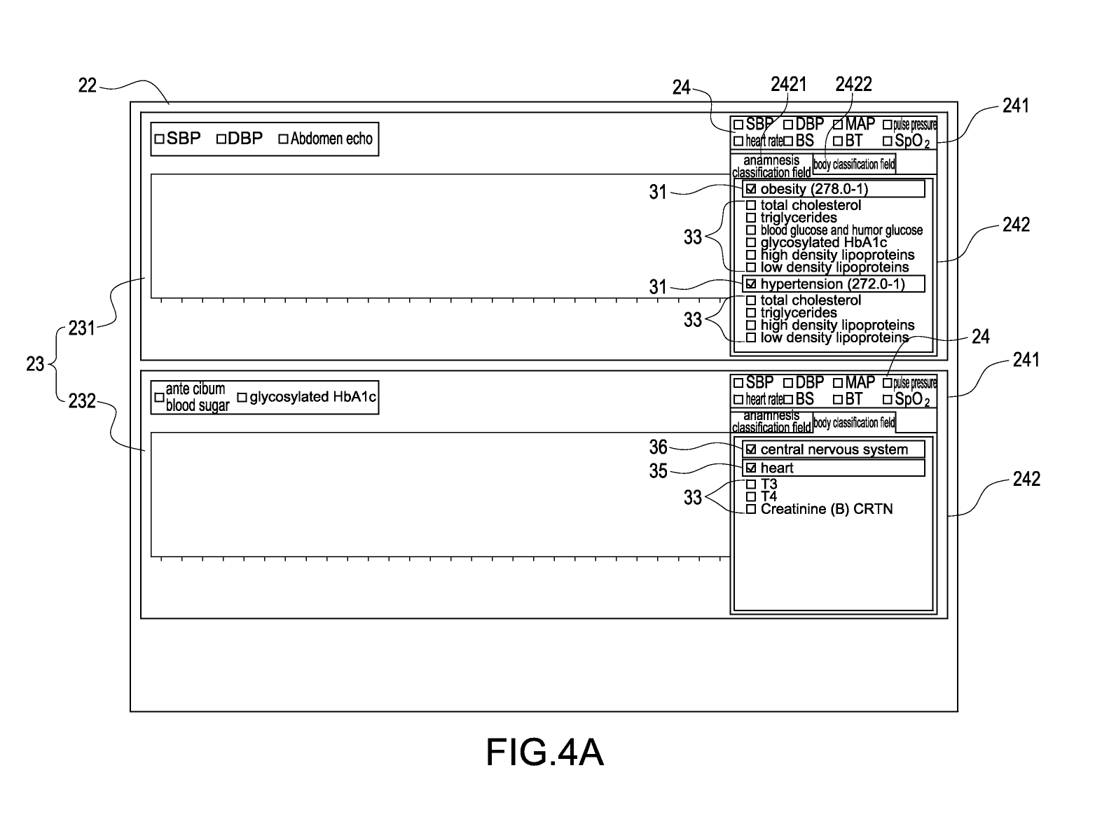

Please refer to FIG. 3, which is a framework view of integrating data of a preferred embodiment according to the invention. The plurality of anamnesis data 30 are integrated by the integrating system 1 of the invention with the disease data 31 corresponding to the classified code data 32, the diagnostic examination data 33, the pharmaceutical data 34 and the organ data 35, and the functional system data 36 corresponding to the organ data 35.

The disease data 31 may record patient's current diseases such as hypertension, diabetes or hepatitis and the like that had been diagnosed by the doctor. Alternatively, the disease data 31 may also predict the possible disease that could occur in the future by analyzing the patient's data comprising but not limited to physical exams, physiological measurement records, personal life style, exercise and diet records, vaccine records, genetic evaluation records and family medical history.

The classified code data 32 corresponded to the disease data 31 may record classified code of the disease data 31. For example, if the disease recorded in the disease data 31 is hepatitis, the classified code data 32 may record at least one classified code, for example: International Classification of Diseases Code (ICD Code) or SNOMED CT. Illustrating the above point with ICD-9 of ICD Code, 070.30 and 070.51 respectively represents hepatitis type B and hepatitis type C. However, the above example is merely an example of preferred embodiment of the invention, and thus the classified code should not be limited to ICD Code or SNOMED CT.

The diagnostic examination data 33 corresponding to the disease data 31 may record inspective examinations performed in a particular time.

For example, if the disease recorded in the disease data 31 is hepatitis, the diagnostic examination data 33 corresponds to at least one inspective examination such as glutamate pyruvate transaminase (GPT), glutamate oxaloacetate transaminase (GOT) and abdomen echo exam, etc. Please note that the data measured and uploaded through the inspective apparatus 6 by the patient are also a part of the diagnostic examination data 33.

In the embodiment, the integrating system 1 of the invention may automatically select the inspective item that relates to the disease indicated by the disease data 31, wherein that selecting mechanism may be default option or the user may add and or remove choices as necessary. Accordingly, the diagnostic examination data 33 that does not relate to the disease indicated by the disease data 31 would not be part of the integration calculation.

The pharmaceutical data 34 corresponded to the disease data 31 may record medication intake by the patient for the disease data 31 in a specific period of time. For example, if the disease recorded in the disease data 31 is hypertension, the pharmaceutical data 34 corresponds to at least one medicine e.g., Norvasc®, for treating hypertension. The pharmaceutical data 34 records the name of medication, frequency of administration of medication (e.g., times per day and dosage) and medication effects on the patient. Also, the pharmaceutical data 34 may correspond to the diagnostic examination data 33 via disease data 31 to validate the treatment efficacy of medication for the disease and determine if medication dosage needs to be altered or perhaps replaced by a different type of medication.

The organ data 35 corresponded to the disease data 31 may record the organ that is affected by the disease. For example, if the disease recorded in the disease data 31 is hepatitis, the organ data 35 may correspond to the liver.

The functional system data 36 may correspond to the organ data 35, and subsequently correspond to the disease data 31. The functional system data 36 records the functional system that is affected by the disease. For example, if the disease recorded in the disease data 31 is hepatitis, the organ data 35 corresponds to the liver and the functional system data 36 corresponds to e.g. digestive system and system of gastroenterology and hepatology.

The most significant feature of the invention is that no matter which item of the plurality of anamnesis data 30 is update by the hospital server 5, the inspective apparatus 6 and or the like, the updated data may be integrated by the integrating system 1 of the invention and be associated to the relevant data pool.

For example, if the pharmaceutical data 34 is updated and shows that the patient is now taking Hepsera®, the disease data 31 should correlate with hepatitis e.g., hepatitis type B and hepatitis type C, because Hepsera® is one kind of medication for treating hepatitis. Also, hepatitis type B (070.30) and hepatitis type C (070.51) corresponding to hepatitis of the classified code data 32 respectively, can be construed from the disease data 31. Further, the inspective items of GPT and GOT related to hepatitis corresponding to the diagnostic examination data 33 can also be construed from the disease data 31. Moreover, the organ affected by the disease corresponding to the organ data 35 is liver can also be construed from the disease data 31. Also, the functional system data 36 is digestive system and system of gastroenterology and hepatology which can be construed from the organ data 35.

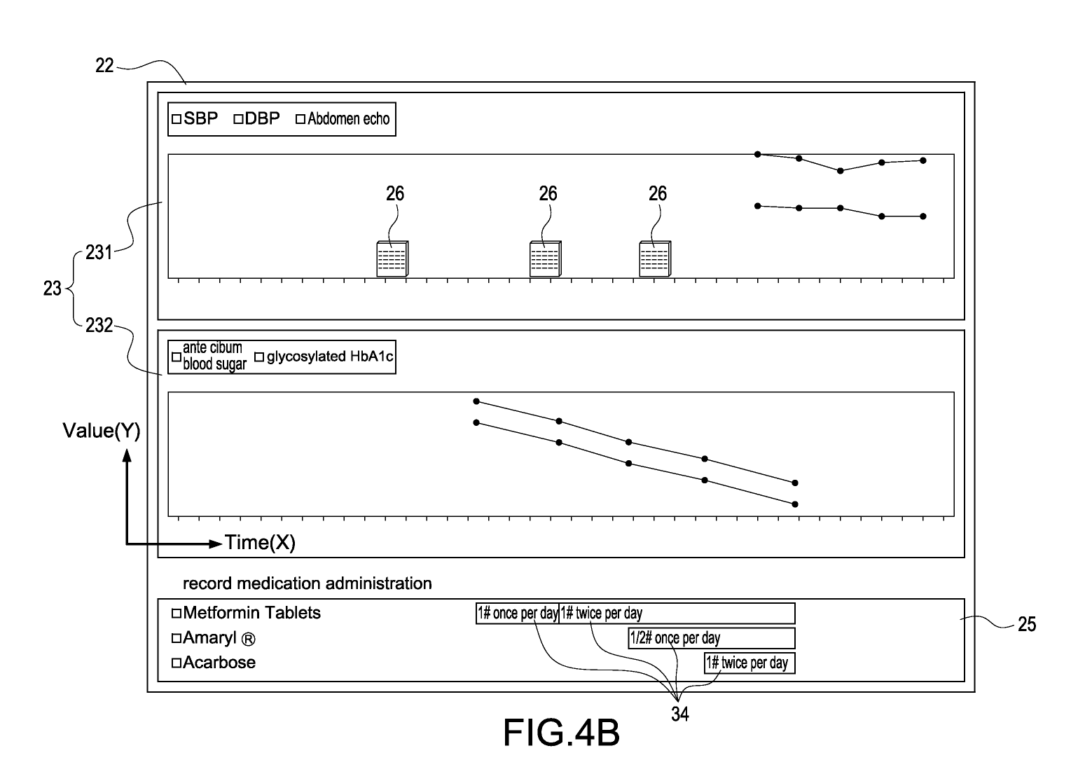

Next, please refer to FIG. 4A and FIG. 4B, wherein FIG. 4A shows a schematic view of displaying page of a preferred embodiment according to the invention, and FIG. 4B shows a schematic view of displaying page of another preferred embodiment according to the invention. The displaying page 22 may provide at least one graphic chart 23, e.g. a first graphic chart 231 and a second graphic chart 232 in the embodiment, but the amount is not limited to the two graphic charts. Each of the graphic chart 23 has a menu 24 including an upper part 241 and a lower part 242. The upper part 241 may display those data in the diagnostic examination data 33, and the lower part 242 has an anamnesis classification field 2421 and a body classification field 2422. The menu 24 may respectively display the disease data 31 of the patient, the organ data 35 and the functional system data 36 according to the anamnesis classification field 2421 and the body classification field 2422.

Please note that the data, e.g. SBP, DBP, MAP, pulse pressure, heart rate, BS, BT and SpO₂ displayed in the upper part 241, but not limited thereto, is generally viewed and updated by user. The user can quickly query the data on the first graphic chart 231 by the use of the upper part 241 of the menu 24.

Next, taking the first graphic chart 231 for example, the menu 24 may list all of the disease data 31 and the diagnostic examination data 33 related to the disease data 31 of the patient in the database 3 in turn in the anamnesis classification field 2421 of the lower part 242. When one of the listed diagnostic examination data 33 is selected, the selected diagnostic examination data 33 is shown on the first graphic chart 231.

Please note that the displaying page 22 also provides at least one medication chart 25 displaying the pharmaceutical data 34 related to the selected diagnostic examination data 33. The pharmaceutical data 34 may display the name of medication, medication dosage, and medication administration log associated with the disease data 31 to construe a correlation with the selected diagnostic examination data 33.

Next, taking the second graphic chart 232 in FIG. 4A for example, the menu 24 may list all of the functional system data 36, the organ data 35 related to the functional system data 36 and the diagnostic examination data 33 related to the organ data 35 of the patient in the body classification field 2422. When one of the listed diagnostic examination data 33 is selected, the selected diagnostic examination data 33 is shown on the second graphic chart 232. Also, the displaying page 22 can display the pharmaceutical data 34 related to the selected diagnostic examination data 33 through the medication chart 25.

The quantity of the graphic chart 23 of the displaying page 22 may depend on the needs of the user. The user may wish to query all of the diagnostic examination data 33 and display it in one graphic chart 23. Alternatively, the plurality of graphic chart 23 may be used based on the number of diseases to display each of the diagnostic examination data 33 respectively, but not limited thereto. Also, in the embodiment, the medication chart 25 may display at the bottom of graphic chart 23 and show more than one pharmaceutical data 34, e.g. the medication chart 25 may display three different therapeutic medicines in FIG. 4B.

As shown in FIG. 4B, the graphic chart 23 has values on the y axis and time on the x axis, and the graphic chart 23 shows the numerical changes of the selected diagnostic examination data 33 in a specific time interval. Also, if the selected diagnostic examination data 33 is a data type which cannot be converted into numerical values such as an image report (e.g. chest radiograph), or examination report, or the combination of the two reports, a representative FIG. 26 may be depicted in the graphic chart 23. When the representative FIG. 26 is selected, the displaying page 22 enlarges the representative FIG. 26 and displays the content. Also, if there are descriptive words in the representative FIG. 26, the key words (e.g. stone is present and or size of tumor) is captured from the representative FIG. 26 to explain the test results. For example, when the representative FIG. 26 (e.g. Abdomen echo inspection) of FIG. 4B is selected, the displaying page 22 enlarges the image and highlights the key words related to the image. In the embodiment, the graphic chart 23 shows the numerical changes of the selected diagnostic examination data 33 with a line plot. Alternatively, if the selected diagnostic examination data 33 is a data type which cannot be converted into numerical values, a representative FIG. 26 may present the selected diagnostic examination data 33.

Further, if the key words of the representative FIG. 26 comprises of numerical values corresponding to the selected diagnostic examination data 33, the numerical values are captured and converted into a line plot. Accordingly when diagnostic examination data 33 is selected, the data is converted into line plot and shown on the graphic chart 23.

The medication chart 25 may show the pharmaceutical data 34 indicating the record of medication administration (e.g., times per day and dosage) of the patient in a specific period of time, and the occurrence of medication administration of the pharmaceutical data 34 corresponds to x axis of the graphic chart 23. Accordingly, the user can clearly see the medicine from pharmaceutical data 34 used at specific time period on the graphic chart 23 and the resulting effect of medication on diagnostic examination data 33. In other words, the user can easily comprehend whether the medication is an effective treatment for the disease and make an evaluation to continue, stop, or alter the use of the current medication treatment regimen.

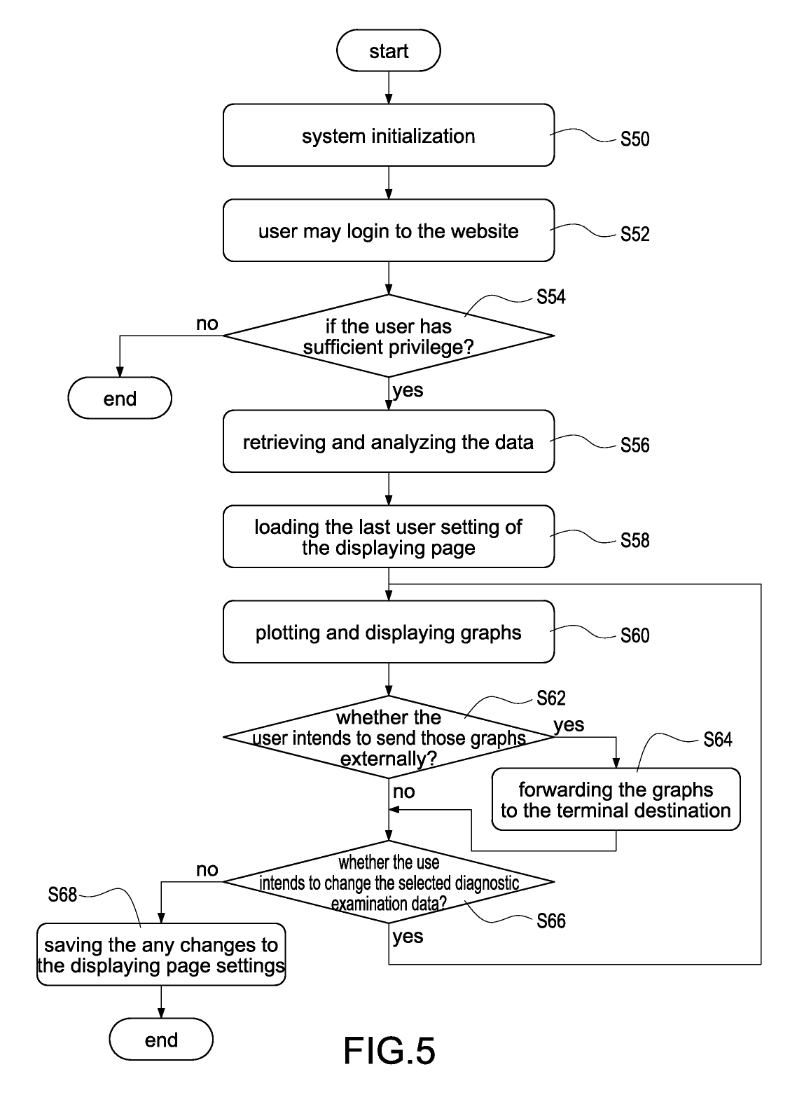

Next, please refer to FIG. 5, which is a flow chart of a preferred embodiment according to the invention. At start, system initialization of the integrating system 1 is performed (step S50), and then a user may login to the website 21 of the server 2 from an external computer 4 (step S52). The integrating system 1 may determine whether the user has sufficient privilege when the user logins (step S54), if the user does not have sufficient privilege, then the integrating system 1 may reject the login of the user.

If the user has sufficient privilege determined via step S54, then the integrating system 1 may retrieve and analyze the data according to the privilege of the user (step S56). For example, if the user has the privilege to query the data of a patient A, the integrating system 1 may retrieve and analyze the anamnesis data of the patient A stored in the database 3 in step S56.

Next, the integrating system 1 may load the last user setting of the displaying page 22 (step S58). Also, the correspondent graphs are plotted and displayed on at least one graphic chart 23 according to the setting of the displaying page 22 (step S60). In the embodiment, the graph is a line plot or the representative FIG. 26. Representative FIG. 26 includes image and/or keywords which cannot be converted into numerical values.

After step S60, the user can query those graphs on the graphic chart 23 directly. Alternatively, the integrating system 1 may determine whether the user intends to send those graphs externally (step S62). If the user intends to send those graphs externally, the integrating system 1 may forward those graphs to the terminal destination indicated by the user by e-mail or short message (step S64).

Further, the integrating system 1 may determine whether the user intends to change the selected diagnostic examination data 33 (step S66), i.e. determining whether the user intends to add or remove any particular diagnostic examination data 33 which are shown in the graphic chart 23. If the user changes the diagnostic examination data 33, the integrating system 1 goes back to step S60 and may plot and display the new graphs according to the changes made by the user.

Finally, when user completes all of the desired actions, the integrating system 1 will save the any changes to the displaying page 22 settings (step S68). Hence upon next user login to the website 21, the integrating system 1 will load the last saved displaying page 22 setting and make plots and display the graphs accordingly.

Above mentioned are simply examples of this inventions and the invention is not limited to these embodiments. Variations and modifications may be made without departing from the scope of the invention.

What is claimed is:

1. An online integrating system for anamnesis, comprising:
a server hosting a website thereon, the website having a displaying page, the displaying page providing at least one graphic chart; and
a database connected to the server, the database storing a plurality of anamnesis data for at least one patient therein; the anamnesis comprising disease data, classified code data, diagnostic examination data and pharmaceutical data; the disease data corresponding to the classified code data, the diagnostic examination data and the pharmaceutical data,
wherein the graphic chart has a menu with an anamnesis classification field, the anamnesis classification field listing all the disease data and the diagnostic examination data related to the disease data of the patient respectively; when one of the listed diagnostic examination data is selected, the selected diagnostic examination data is displayed on the graphic chart; the displaying page further provides a medication chart for displaying the pharmaceutical data related to the selected diagnostic examination data, the pharmaceutical data interrelates to the selected diagnostic examination data by the related disease data.

2. The online integrating system for anamnesis as claimed in claim 1, wherein the graphic chart has values on the y axis and time on the x axis, the graphic chart shows the numerical changes of the selected diagnostic examination data in a specific time interval by a plotted line, and the medication chart shows the name of medicine and the effect of medicine on the patient in a specific period indicated in the pharmaceutical data.

3. The online integrating system for anamnesis as claimed in claim 2, wherein the graphic chart contains a representative figure, the representative figure is used to depict diagnostic examination data which cannot be converted into numerical values, representative figure comprise of images and relevant keywords, and the keywords may include numerical type text related to the exam data, the numerical type text are captured and converted into plottable lines to display on the respective chart thereof.

4. The online integrating system for anamnesis as claimed in claim 2, wherein the displaying page provides a plurality of graphic charts respectively displaying the diagnostic examination data of different diseases, and the medication chart displays on the bottom of graphic chart and shows more than one pharmaceutical data to correspond the different diagnostic examination data.

5. The online integrating system for anamnesis as claimed in claim 1, wherein the plurality of anamnesis data further include organ data corresponding to the disease data, the menu further includes a body classification field listing all the organ data and the diagnostic examination data related to the organ data of the patient in turn; when one of the listed diagnostic examination data is selected, the selected diagnostic examination data is shown on the graphic chart.

6. The online integrating system for anamnesis as claimed in claim 5, wherein the plurality of anamnesis data further include functional system data corresponding to the organ data, the menu further includes a body classification field listing all the functional system data, the organ data related to the functional system data and the diagnostic examination data related to the organ data of the patient in turn; when one of the listed diagnostic examination data is selected, the selected diagnostic examination data is shown on the graphic chart.

7. The online integrating system for anamnesis as claimed in claim 6, wherein the menu includes an upper part for displaying the basic physiological data in the diagnostic examination data and a low part for displaying an anamnesis classification field and a body classification field.

8. The online integrating system for anamnesis as claimed in claim 7, wherein the basic physiological data include at least one systolic blood pressure (SBP), diastolic blood pressure (DBP), mean arterial pressure (MAP), pulse pressure, heart rate, blood sugar, body temperature and oxygen saturation (SPO₂).

9. The online integrating system for anamnesis as claimed in claim 7, further including at least one inspective apparatus connected to the server by networking system, and the patient completes a physiological measurement by the inspective apparatus, and uploads the physiological data to update the diagnostic examination data of the plurality of anamnesis data.

10. The online integrating system for anamnesis as claimed in claim 1, further including at least one hospital server connected to the server by networking system, and the hospital server uploads the anamnesis data of the patient to update the plurality of anamnesis data of the patient in the database.

11. The online integrating system for anamnesis as claimed in claim 1, wherein the classified code is International Classification of Diseases Code (ICD Code) or SNOMED CT.
